(19) United States
(12) Patent Application Publication
(10) Pub. No.: US 2014/0263277 A1
(43) Pub. Date: Sep. 18, 2014

(54) HEATING PLATE

(71) Applicant: SHUI-PO LEE, Miaoli County (TW)

(72) Inventor: SHUI-PO LEE, Miaoli County (TW)

(21) Appl. No.: 13/800,037

(22) Filed: Mar. 13, 2013

(51) Int. Cl. H05B 3/74

(52) U.S. Cl. CPC H05B 3/748
USPC 219/468.1

(57) ABSTRACT

A heating plate includes a thermally conductive, electrically insulating main board on whose surface an electrically-conductive heat-generating circuit and an outer insulating layer are layered. The heat-generating circuit is formed by connecting one first electrically-conductive layer and one second electrically-conductive layer that are arranged in different directions. The first and second electrically-conductive layers are overlapped to form an overlapping area. The heat-generating circuit has at least two electrically-conductive segments exposed outside the outer insulating layer. Thereby, when the electrically-conductive segments receive incoming current, the electrically-conductive heat-generating circuit can generate heat rapidly, and the heat can be transmitted to the main board through the thermally-conductive insulating layer. The overlapping area formed at each turning point along the electrically-conductive heat-generating circuit is more capable of load bearing so that the electrically-conductive heat-generating circuit is unlikely to be damaged at the turning point.

### BACKGROUND OF THE INVENTION

1. Technical Field

The present invention relates to heating plates, and more particularly, to a heating plate that provides benefits of fast heating response, strong structural integrity, high mechanical strength and excellent resistant to thermal shock and high temperature embrittlement.

2. Description of Related Art

The conventional boilers or steam pipes typically use electric heating devices such as metal heating rods, heating wire and metal heating foil to heat liquid (such as water and oil), and these heating devices are mostly made of electrothermal alloy.

One kind of conventional metal heating rods, for example, as disclosed in Taiwan Patent M364834, is a U-shaped heating device that generates heat when electric power is applied to its ends. Such a heating rod responds slowly and is disadvantageous when the application needs fast heating. Furthermore, for compensate for said slow response, the conventional heating devices made of electrothermal alloy have to directly contact the liquid to be heated (e.g. water) so as to improve the resultant heat exchange. However, direct exposure to liquid can cause metal parts in the device to oxidize prematurely, with the service life no longer than 3000 hours.

On the other hand, the conventional heating wires and metal heating foil, due to their thin structure, typically lack of strength and tend to suffer high temperature embrittlement. In the case where such a device is excessively heavy, or is not well installed or supported, the embrittled parts can deform and cause the whole structure to collapse. Additionally, for maximizing heating efficiency in a given area, the heating wires and metal heating foil are usually arranged into a coil-like or continuous S-shaped patter. However, the electric current flowing across the device tends to concentrates at the turning corners along the path and makes the turning points excessively heat. Without being widened or thickened at the turning points, the electrothermal-alloy heating wire or the heating foil can easily be burned out, resulting in either a disadvantageously restricted current carrying ability or reduced service life of the overall heating device.

### SUMMARY OF THE INVENTION

According to the present invention, a heating plate comprises:

a main board being thermally conductive and electrically insulating;

an electrically-conductive heat-generating circuit being mounted on an external surface of the main board and made of at least one first electrically-conductive layer and at least one second electrically-conductive layer such that an overlapping area is formed at a site where the first electrically-conductive layer and the second electrically-conductive layer contact and overlap each other, in which the electrically-conductive heat-generating circuit has at least two electrically-conductive segments; and

an outer electrically-insulating layer being mounted an external surface of the electrically-conductive heat-generating circuit so as to sandwich the electrically-conductive heat-generating circuit between the main board and the outer electrically-insulating layer in such a manner that the electrically-conductive segments are exposed outside the outer electrically-insulating layer.

One objective of the present invention is to provide a heating plate wherein the electrically-conductive heat-generating circuit and the outer electrically-insulating layer are closely combined on the main board. As the functional layers are bound to the main board firmly, the whole assembly has the benefits of strong structural integrity and excellent resistant to vibration and thermal shock. In addition, the electrically-conductive heat-generating circuit is well supported by the main board, so the heat generated during the heating process can be conducted to the main board quickly, without the risk of high temperature embrittlement as occurring in electrothermal-alloy devices and the risk of deformation or collapse caused by weak support or improper installation.

Another objective of the present invention is to provide a heating plate wherein the first electrically-conductive layer is arranged on the external surface of the main board in a first direction while the second electrically-conductive layer is arranged on the external surface of the main board in a second direction, in which the first and second directions are orthogonal to each other, so that the first electrically-conductive layer and the second electrically-conductive layer form overlapping areas at the turning points where they contact each other. The overlapping areas help to promote the current carrying ability of the electrically-conductive heat-generating circuit and prevent the turning point from failure.

Another objective of the present invention is to provide a heating plate wherein the electrically-conductive heat-generating circuit further has at least one rounded corner at the turning points for preventing electric current flowing along the circuit from concentrating at and burning out the turning points.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a heating plate according to the present invention;

FIG. 2 is an exploded view of the heating plate of FIG. 1;

FIG. 3 is a partial, enlarged view of FIG. 1;

FIG. 4 is a cross-sectional view of the heating plate taken along Line 4-4 of FIG. 1; and

FIG. 5 is a cross-sectional view of the heating plate taken along Line 5-5 of FIG. 1.

### DETAILED DESCRIPTION OF THE INVENTION

Referring to FIG. 1 through FIG. 3, according to the present invention, a heating plate comprises a main board 1, an electrically-conductive heat-generating circuit 30 and an outer electrically-insulating layer 40.

The main board 1 may be made of a material that is thermally conductive and electrically insulating. In one embodiment, the main board 1 is a glass board. Alternatively, the main board 1, as shown in FIG. 2, is composed of a thermally-conductive board 10 and a thermally-conductive electrically-insulating layer 20 deposited on the top of the thermally-conductive board 10. Therein, the thermally-conductive board 10 may be at least one of a stainless steel board, a metal board and a sintered metal board, and the thermally-conductive electrically-insulating layer 20 is a glass glaze layer. The main board 1 may be fixed to the exterior of a boiler or a liquid container by means of, for example, screwing, embedding or soldering.

The electrically-conductive heat-generating circuit 30 is deposited on the external surface of the thermally-conductive electrically-insulating layer 20, and is composed of at least one first electrically-conductive layer 31 and at least one second electrically-conductive layer 32. Where the first and second electrically-conductive layers 31, 32 joint are formed with overlapping areas 33 that are constructed from the stacked first and second electrically-conductive layers 31, 32 (as shown in FIG. 4). The electrically-conductive heat-generating circuit 30 has at least two electrically-conductive segment 34.

The outer electrically-insulating layer 40 is deposited on the external surface of the electrically-conductive heat-generating circuit 30, for sandwiching the electrically-conductive heat-generating circuit 30 between the thermally-conductive electrically-insulating layer 20 and the outer electrically-insulating layer 40. The outer electrically-insulating layer 40 may be a layer of glass glaze. Therein, the electrically-conductive segment 34 is at least partially exposed outside the outer electrically-insulating layer 40, for an electrically-conductive member 35 to connect thereto (as shown in FIG. 5).

In one preferred embodiment, the main board 1 is a rectangular board having a pair of first edges 11 and a pair of second edges 12. The first electrically-conductive layer 31 is arranged on the external surface of the thermally-conductive electrically-insulating layer 20 in a first direction a, while the second electrically-conductive layer 32 is arranged on the external surface of the thermally-conductive electrically-insulating layer 20 in a second direction b. Therein, the first direction a is parallel to the first edges 11, and the second direction b is parallel to the second edges 12, so that the first and second directions a, b are orthogonal to each other. As a result, the first and second electrically-conductive layers 31, 32 jointly form the electrically-conductive heat-generating circuit 30 with a continuous S-shaped pattern. Moreover, the electrically-conductive heat-generating circuit 30 has at least one rounded corner 36 at its turning points.

The thermally-conductive electrically-insulating layer 20, the electrically-conductive heat-generating circuit 30 and the outer electrically-insulating layer 40 may be successively formed on the thermally-conductive board 10 through a vacuum screen-printing process and baked respectively, so as to firmly bounded with the thermally-conductive board 10.

In use, referring to FIG. 1 and FIG. 5, when electric current is input to the electrically-conductive heat-generating circuit 30 through the electrically-conductive member 35, the resistance of the electrically-conductive heat-generating circuit 30 converts the current into heat. Then the heat generated by the electrically-conductive heat-generating circuit 30 is transmitted to the main board 1 through the thermally-conductive electrically-insulating layer 20, for the main board 1 to heat any article to be heated. The disclosed heating plate thus has the advantages of quick heating response and fast actuation of the electrically-conductive heat-generating circuit 30. The heating rate at the surface of the heat-generating circuit is up to 250-300° C./s, being superior to the traditional electrothermal-alloy devices. As shown in Table 1 below, in an experiment where the same current (220V, 10 A) was applied to a conventional electrothermal-alloy device (i.e. heating rod) and the disclosed heating plate to heat 1,000 cc of water into steam, the disclosed heating plate exhibited a heat efficiency much higher than that of the conventional electrothermal-alloy device, demonstrating that the disclosed heating plate is more advantageous than the conventional electrothermal-alloy device when fast heating is required.

TABLE 1

| | 24-100° C. | 24-110° C. | 24-120° C. | 24-130° C. | 24-140° C. | 24-150° C. |
|---|---|---|---|---|---|---|
| Heating | 3.05 minutes | 4.43 minutes | 4.90 minutes | 5.50 minutes | 6.25 minutes | 7.58 minutes |
| Rod | | | | | | |
| Disclosed | 2.00 minutes | 2.40 minutes | 2.88 minutes | 3.37 minutes | 4.23 minutes | 5.52 minutes |
| Heating | | | | | | |
| Plate | | | | | | |

Additionally, in the disclosed heating plate, the thermally-conductive electrically-insulating layer 20, the electrically-conductive heat-generating circuit 30 and the outer electrically-insulating layer 40 are closely affixed to the main board 1, so the strong binding between the main board 1 and the functional layers provides the benefits of high mechanical strength and excellent resistant to vibration and thermal shock. In addition, the electrically-conductive heat-generating circuit 30 is well supported by the main board 1, so the heat generated during the heating process can be conducted to the main board 1 quickly, without the risk of high temperature embrittlement as occurring in electrothermal-alloy devices and the risk of deformation or collapse caused by weak support or improper installation.

The disclosed main board 1 may be further fixed to the exterior of a boiler or a liquid container by means of, for example, screwing, embedding or soldering. Accordingly, the heating plate is isolated from the liquid to be heated, and less likely to oxidize, thereby having long service life. In addition, since the electrically-conductive heat-generating circuit 30 is sandwiched between the main board 1 and the outer electrically-insulating layer 40, it is relatively isolated from the atmosphere and can have its service life lengthened to more than then thousand hours.

As shown in FIG. 3 and FIG. 4, according to the present invention, the first electrically-conductive layer 31 and the second electrically-conductive layer 32 jointly form the electrically-conductive heat-generating circuit 30 that has a continuous S-shaped pattern, and has every point where the circuit veers formed with the thickened overlapping area 33, so as to effectively prevent the turning points from being burned out by concentrated current, thereby providing the electrically-conductive heat-generating circuit 30 with increased current carrying ability. Similarly, as shown in FIG. 1, the electrically-conductive heat-generating circuit 30 may have its turning points formed as rounded corners 36, which can help reduce current concentration at the turning points as compared to traditional right-angle corners.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A heating plate comprising:
a main board, thermally conductive and electrically insulating;
an electrically-conductive heat-generating circuit, mounted on an external surface of the main board and made of at least one first electrically-conductive layer and at least one second electrically-conductive layer such that an overlapping area is formed at a site where the first electrically-conductive layer and the second electrically-conductive layer contact and overlap each other, in which the electrically-conductive heat-generating circuit has at least two electrically-conductive segments; and
an outer electrically-insulating layer, mounted an external surface of the electrically-conductive heat-generating circuit so as to sandwich the electrically-conductive heat-generating circuit between the main board and the outer electrically-insulating layer in such a manner that the electrically-conductive segments are exposed outside the outer electrically-insulating layer.

2. The heating plate of claim 1, wherein the electrically-conductive segments are configured to receive and electrically communicate with an external electrically-conductive member.

3. The heating plate of claim 1, wherein the outer electrically-insulating layer is made of glass glaze.

4. The heating plate of claim 1, wherein the electrically-conductive heat-generating circuit is made of an electrically-conductive material.

5. The heating plate of claim 1, wherein the electrically-conductive heat-generating circuit has at least one turning point formed as a rounded corner.

6. The heating plate of claim 1, wherein the main board is made of glass.

7. The heating plate of claim 1, wherein the main board comprises a thermally-conductive board and a thermally-conductive electrically-insulating layer deposited on a surface of the thermally-conductive board.

8. The heating plate of claim 7, wherein the thermally-conductive electrically-insulating layer is made of glass glaze.

9. The heating plate of claim 7, wherein the thermally-conductive board is at least one of a stainless-steel board, a metal board and a sintered metal board.

10. The heating plate of claim 1, wherein the first electrically-conductive layer is arranged on an external surface of the thermally-conductive electrically-insulating layer in a first direction, and the second electrically-conductive layer is arranged on the external surface of the thermally-conductive electrically-insulating layer in a second direction, with the first direction and the second direction being orthogonal to each other.
